(19) United States
(12) Patent Application Publication
(10) Pub. No.: US 2008/0023128 A1
(43) Pub. Date: Jan. 31, 2008

(54) SQUIRREL BARRIER AND METHOD THEREFOR

(76) Inventor: Ronald W. Kaechle, Lake Station, IN (US)

Correspondence Address: HARTMAN & HARTMAN, P.C., 552 EAST 700 NORTH, VALPARAISO, IN, 46383, US

(21) Appl. No.: 11/558,950

(22) Filed: Nov. 13, 2006

Related U.S. Application Data
(60) Provisional application No. 60/820,556, filed on Jul. 27, 2006.

(51) Int. Cl. B29C 53/00

(52) U.S. Cl. 156/217

(57) ABSTRACT

A self-adhesive, flexible, and malleable sheet material and a squirrel barrier method utilizing the sheet material by which squirrels and other animals with claws are prevented from climbing trees and other upright structures. The user determines the length of sheet material needed, marks the appropriate distance on the sheet material, and then cuts the sheet material at this mark. A protective peel-away coating is removed from an adhesive coating on the sheet material, which can then be wrapped around an upright structure.

### CROSS REFERENCE TO RELATED APPLICATIONS

This application claims the benefit of U.S. Provisional Application No. 60/820,556, filed Jul. 27, 2006, the contents of which are incorporated herein by reference.

### BACKGROUND OF THE INVENTION

The present invention generally relates to climbing barrier, and more particularly to a self-adhesive, flexible, and malleable barrier and a method of applying the barrier to effectively prevent squirrels and similar animals from climbing trees, poles, and the like.

Squirrels can create a variety of problems for home owners. Squirrels become a nuisance by eating fruit, nuts, and acorns from trees and by eating food in bird feeders. More critically, squirrels can cause extensive damage to homes by gnawing on attic insulation, walls, and electrical wiring. Often in such cases, the squirrel enters home by climbing a tree and then accessing the home from this elevated perch. If squirrels are prevented from climbing the trees, then these types of problems will be avoided.

### BRIEF SUMMARY OF THE INVENTION

The invention is directed to a self-adhesive, flexible, and malleable climbing barrier, and to a method utilizing the barrier to prevent squirrels and similar animals from climbing trees, poles, and the like.

The invention generally entails the use of a laminate material comprising a flexible malleable sheet material, an adhesive coating on a surface of the sheet material, and a releasable protective sheet overlying the adhesive coating so that the adhesive coating is between and protected by the sheet material and the protective sheet. The method of this invention generally involves cutting a length of the laminate material, removing the protective sheet to expose the adhesive coating on the sheet material, and then wrapping the sheet material around an upright structure such that the sheet material encircles the structure and the adhesive coating contacts the structure and adheres the sheet material to the structure. The sheet material has a surface opposite the adhesive coating that is sufficiently smooth, hard, and nonporous to provide a physical barrier to being climbed by an animal with claws and otherwise capable of climbing the structure.

In view of the above, it can be seen that a significant advantage of this invention is that a supply of the sheet material can be cut and quickly and easily applied to a variety of vertical or otherwise upright surfaces, including trees, posts, poles, etc. Since the user can measure and cut the laminate material to the required length to create multiple barriers, it is not necessary to know in advance the exact number of barriers that would otherwise have to be purchased. This is a convenience for the user who now may only need to purchase a single roll of the laminate material. Additionally, the laminate material can be formed of a material that can be cut with scissors or another cutting tool, such that specialized tools are not required to install the barrier. The adhesive coating on the sheet material enables the barrier to be installed without the need for any additional fasteners or the separate application of an adhesive. The adhesive also permits the barrier to be removed and reapplied later at the same or different location.

Other objects and advantages of this invention will be better appreciated from the following detailed description.

### BRIEF DESCRIPTION OF THE DRAWINGS

FIG. 1 is a perspective view of a roll of laminate material from which a climbing barrier can be cut in accordance with a preferred embodiment of the invention.

FIG. 2 is a cross-sectional view of the laminate material of FIG. 1.

FIG. 3 is another perspective view of the laminate material of FIG. 2, in which the laminate material has been marked for cutting to a desired length.

FIG. 4 is a perspective view showing a cut length of the laminate material, with a corner of a protective backing peeled back to expose an adhesive on a surface of a flexible sheet material.

FIG. 5 is a perspective view illustrating the cut laminate material of FIG. 4 partially wrapped around a pole following removal of the protective backing.

FIG. 6 is a perspective view of the laminate material after application is complete and showing an end-to-end overlap.

### DETAILED DESCRIPTION OF THE INVENTION

The invention is directed to the use of a flexible, and malleable sheet material adapted to be wrapped around upright structures, including trees, poles, posts, etc., for the purpose of inhibiting animals from climbing such upright structures. As evident from the following, the sheet material enables a user to quickly and easily protect his or her property from the annoying and possibly harmful effects of squirrels and other similar climbing animals.

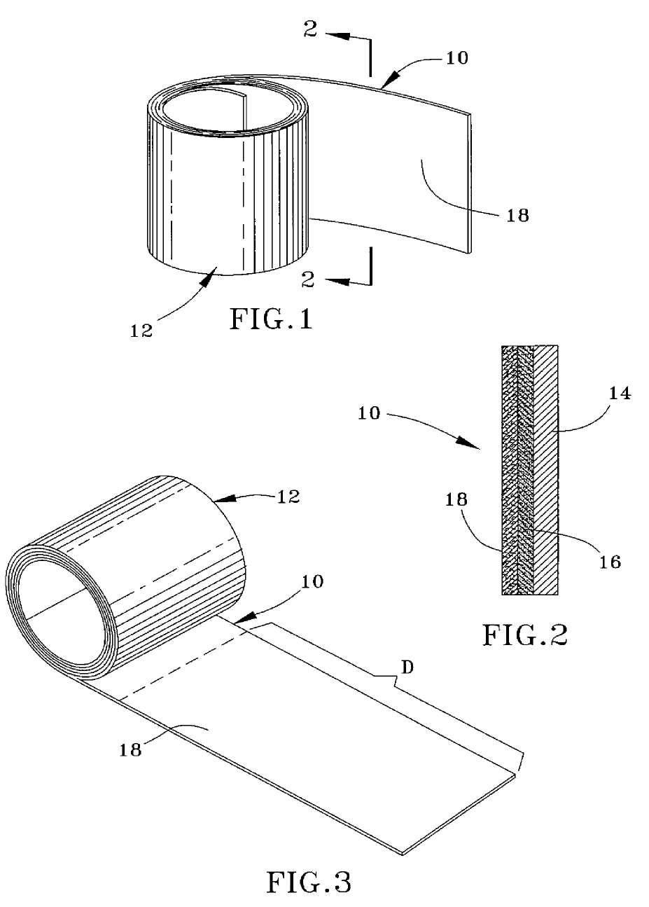

As depicted in FIGS. 1 and 2, a laminate material 10 of a type suitable for use with the invention is shown in the form of a roll 12 for ease of transport and handling 10. The laminate material 10 includes a lightweight, flexible, and malleable sheet material 14, an adhesive coating 16 on a surface of the sheet material 14, and a protective backing 18 overlying the adhesive coating 16. While the adhesive coating 16 is represented as entirely covering the surface of the sheet material 14, it is foreseeable that the coating 16 could be limited to one or more edges of the sheet material 14. A wide variety of adhesive materials are suitable for use as the adhesive coating 16, the only requirements being that the backing 18 can be released from the adhesive coating 16 and the adhesive is sufficiently tacky to bond to the sheet material 14. Suitable materials for the backing 18 include paper or another sheet materials that have limited adhesion to the particular adhesive used for the coating 16. Because squirrels and similar animals climb by using their claws to grip relatively soft and/or rough surfaces, the surface of the sheet material 14 opposite the adhesive coating 16 is relatively smooth, hard, and nonporous to provide a physical barrier to being climbed. Suitable materials for this purpose include but are not limited to aluminum, stainless steel, or other materials with suitable flexibility to permit being deformed by hand when wrapped around a columnar-type structure, such as a tree, post, pole, etc. The sheet material 14 is preferably made available in a size that is convenient for the user to work with and install. A suitable width dimension for the sheet material 14 is believed to be approximately 8 inches (about 20 cm), although other widths are foreseeable.

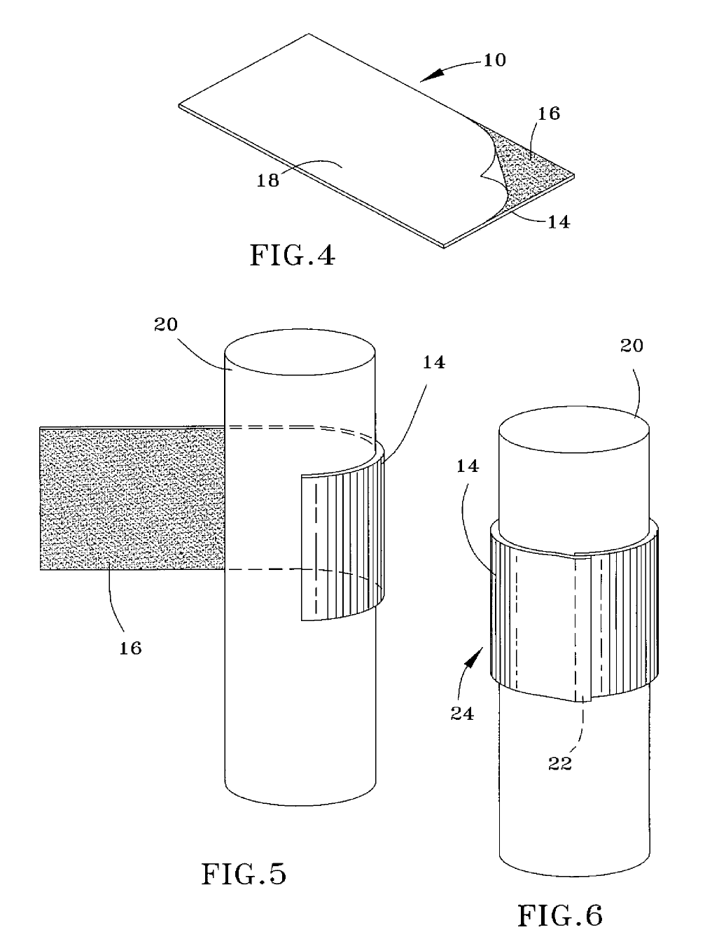

Ease of installation is a particular advantage of the present invention. A user first measures the circumference of the tree, post, pole, or other upright structure 20 (e.g., 20 in FIG. 5) on which the sheet material 10 is to be installed to form a climbing barrier (24 in FIG. 6). The laminate material 10 is then unrolled (FIG. 1) and cut to a length “D” (FIG. 3) that is greater than the circumference of the structure 20 to provide an end-to-end overlap 22 of the laminate material 10 when installed, as represented in FIG. 6. The end-to-end overlap 22 creates a more durable installation by allowing the sheet material 14 to adhere to itself as well as the structure 20 and create uninterrupted coverage of the sheet material 14 encircling the structure 20. A suitable width for the end-to-end overlap 22 may be as little as about one inch (about 2.5 cm). The desired length measurement, D, for the sheet material 14 is shown in FIG. 3 as being measured and marked, such as with a marker or other writing instrument, prior to cutting the laminate material 10 with scissors or a similar cutting utensil. The protective peel-away backing 18 can then be removed from the sheet material 14 to expose the adhesive coating 16, as shown in FIG. 4. When wrapping of the structure 20 as represented in FIGS. 5 and 6, the segment of the sheet material 14 is preferably oriented so that its length is perpendicular to the axial direction of the structure 20 being wrapped. One end of the segment can be pressed firmly against the structure 20 at any desired height (FIG. 5), after which the segment is tightly wrapped around the structure 20 until the sheet material 14 is completely installed to achieve the end-to-end overlap 22 (FIG. 6).

From the above, it can be appreciated that the roll 12 of laminate material 10 can be sized to enable segments of sheet material 14 of various lengths to be cut to protect multiple structures of various sizes. Whereas methods that involve the purchase of individual barriers require prior knowledge of the exact number of structures to be protected, the method of this invention allows a user to be less precise. Another advantage is that attachment of the sheet material 14 is with the adhesive coating 16 and without additional mechanical fasteners or a separately applied adhesive. As such, only a limited number of tools are necessary, for example, a tape measure or other instrument to measure the desired length of sheet material 14, a marker to mark the measured length of laminate material 10, and scissors or another suitable instrument for cutting the measured length of laminate material 10. Such steps and the installation of the cut sheet material 14 can be performed by an individual without additional help.

Notably, the sheet material 14 and its installation method also allow for ease of removal and re-use. If it becomes necessary or desirable, the sheet material 14 can be repositioned on the same structure 20, moved to a different location, or removed and saved for future use without the need for any tools.

While the invention has been described in terms of a preferred embodiment, it is apparent that other forms could be adopted by one skilled in the art. For example, the invention is not limited to squirrels, but is effective against a variety of climbing animals that use their claws to grip a surface being climbed, and is not limited to trees or poles, but can be effectively applied to a variety of upright structures that may be climbed by a clawed animal. Therefore, the scope of the invention is to be limited only by the following claims.

1. A method of providing a climbing barrier on an upright structure, the method comprising:
providing a laminate material (10) comprising a flexible malleable sheet material (14), an adhesive coating (16) on a surface of the sheet material (14), and a releasable protective sheet (18) overlying the adhesive coating (16) so that the adhesive coating (16) is between and protected by the sheet material (14) and the protective sheet (18);
cutting a length of the laminate material (10);
removing the protective sheet (18) to expose the adhesive coating (16) on the sheet material (14); and
wrapping the sheet material (14) around an upright structure (20) such that the sheet material (14) encircles the structure (20) and the adhesive coating (16) contacts the structure (20) and adheres the sheet material (14) to the structure (20), wherein the sheet material (14) has a surface opposite the adhesive coating (16) that is sufficiently smooth, hard, and nonporous to provide a physical barrier to being climbed by an animal with claws and otherwise capable of climbing the structure (20).

2. The method according to claim 1, wherein the sheet material (14) is formed of a metal material.

3. The method according to claim 1, wherein the sheet material (14) has a width of about 20 cm.

4. The method according to claim 1, wherein laminate material (10) is provided in a roll that is at least partially unrolled prior to the cutting step.

5. The method according to claim 1, wherein the adhesive coating (16) is only on one surface of the sheet material (14).

6. The method according to claim 1, wherein ends of the sheet material (14) are overlapped as a result of the wrapping step.

7. The method according to claim 1, wherein the sheet material (14) is secured to the structure (20) without additional fasteners other than the adhesive coating (16).
